(19) United States
(12) Patent Application Publication
(10) Pub. No.: US 2021/0041072 A1
(43) Pub. Date: Feb. 11, 2021

(54) Light Collector

(71) Applicant: Lin-Hung CHANG, Tainan City (TW)

(72) Inventor: Ching-Chieh Yang, Kaohsiung City (TW)

(21) Appl. No.: 16/614,528

(22) PCT Filed: Apr. 27, 2018
(86) PCT No.: PCT/CN2018/084908

§ 371 Date: Nov. 18, 2019

(51) Int. Cl. F21S 11/00; G02B 3/08

(52) U.S. Cl. CPC F21S 11/002; F24S 23/31; F21S 11/007; G02B 3/08

(57) ABSTRACT

A light collector (1), a plurality of densely distributed light collecting protrusions (11) protruding upward from the light collector (1), and a light collecting curved surface (111) is provided on the light collecting protrusions (11) in a curved manner; a plurality of densely distributed Fresnel lenses (12) protruding downward from the light collector (1), and a light emitting curved surface (121) being provided underneath the Fresnel lenses (12) in a curved manner. The light collector (1) of the present invention has low production cost and an effect of increasing light usage rate.

### TECHNOLOGICAL FIELD

The present invention relates to a light collector and, more particularly, to a light collector that has an upper end provided with light collecting projections for gathering light rays and has a lower end provided with Fresnel lenses.

### BACKGROUND TECHNOLOGY

As shown in FIG. 1, a light guiding tube 11 penetrates a warm house plant factory roof 2. The light guiding tube 11 has an inner wall provided with a reflective film 111. A light emitting unit 12 is mounted on the lower end of the light guiding tube 11. The light emitting unit 12 includes a glare-proof acrylic board 121 and a light diffusion acrylic board 122. A light collective hood 14 is mounted on the upper end of the light guiding tube 11. The light collective hood 14 has a hollow semispherical shape, and is formed integrally by acrylic material.

When the light guiding tube 11 is used, the light rays “A” pass through the light collective hood 14 into the light guiding tube 11, and are reflected by the reflective film 111 of the light guiding tube 11 to the glare-proof acrylic board 121 and the light diffusion acrylic board 122. The light guiding tube 11 utilizes the glare-proof acrylic board 121 and the light diffusion acrylic board 122 to evenly scatter the light rays “A” to a place under the warm house plant factory roof 2.

However, when the light guiding tube 11 is made, an acrylic board is pressed by a mold with a high price and bent into the hollow semispherical light collective hood 14, while the light guiding tube 11, the glare-proof acrylic board 121 and the light diffusion acrylic board 122 are assembled, to increase the whole assembly cost, such that connection of the light collective hood 14 and the light guiding tube 11 does not satisfy the requirement of the industry with a high price inflation. In addition, each of the light rays “A” is an energy that is consumed gradually after deflection. Thus, the light rays “A” are consumed when passing the light collective hood 14. After the light rays “A” are reflected by the reflective film 111 and refracted by the glare-proof acrylic board 121 and the light diffusion acrylic board 122, the light rays “A” are less than 40%.

Thus, it is known that, the light collective hood 14 and the light guiding tube 11 made at a high cost will consume the energy of the light rays “A”, and will not satisfy the modern industry with high price, inflation, and labor cost. Thus, the light collective hood 14 and the light guiding tube 11 are matters that have to be abandoned.

### SUMMARY OF THE INVENTION

According to the abovementioned description, it is known that the light collective hood and the light guiding tube have the problem of a high cost of fabrication, and have a drawback of consuming usage of the light rays, thus, the inventor of the present invention intends to enhance usage of the light rays and reduce the whole cost, and the inventor considers in many ways, to provide a light collector made of a board.

The present invention is to provide a light collector, wherein, the light collector is a transparent board, the light collector has an upper end provided with a plurality of light collecting projections that are distributed densely, each of the light collecting projections has an upper end provided with at least one light collecting curved surface that increases an area and an angle for gathering light rays; the light collector has a lower end provided with a plurality of protruding Fresnel lenses that are distributed densely, and each of the Fresnel lenses has a lower end provided with at least one arcuate light output surface.

Then, the arcuate light output surface has a periphery provided with one to five arcuate light output rings. The light collecting projections are provided with a light collecting cone rising column, the light collecting cone rising column has a side provided with a light collecting cone curved surface for increasing an upward collecting area of the light rays, and the top of the light collecting cone rising column has the light collecting curved surface.

The object of the present invention is in that, the upper end of the light collector is provided with the light collecting projections for collecting the light rays, and the light rays pass through the light collecting projections, are polarized, and are gathered and irradiated straightly downward through the Fresnel lenses, to increase usage of the light rays.

### DESCRIPTION OF THE ATTACHED DRAWING(S)

FIG. 1 is a schematic view of a conventional light guiding tube in accordance with the prior art.

FIG. 2 is a schematic view of a light collector of the present invention.

FIG. 3 is a bottom view of the light collector of the present invention.

FIG. 4 is a schematic view of light collecting cone rising columns and arcuate light output rings of the present invention.

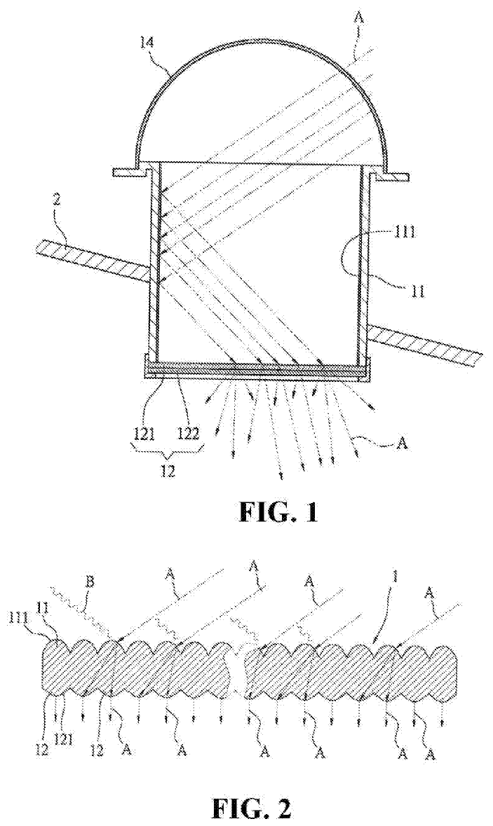

### SYMBOL DESCRIPTION OF THE ATTACHED DRAWINGS

Symbol Description in the Background Technology:

A: light rays; 11: light guiding tube; 111: reflective film; 12: light emitting unit; 121: glare-proof acrylic board; 122: light diffusion acrylic board; 14: light collective hood; 2: warm house plant factory roof;

Symbol Description in the Present Invention:

A: light rays; B: thermal energy; 1: light collector; 11: light collecting projection; 111: light collecting curved surface; 112: light collecting cone rising column; 113: light collecting cone curved surface; 12: Fresnel lens;

121: arcuate light output surface; 122: arcuate light output ring.

Embodying Practice Manner

For further understanding of the present invention, a description is provided in accordance with the following embodiments.

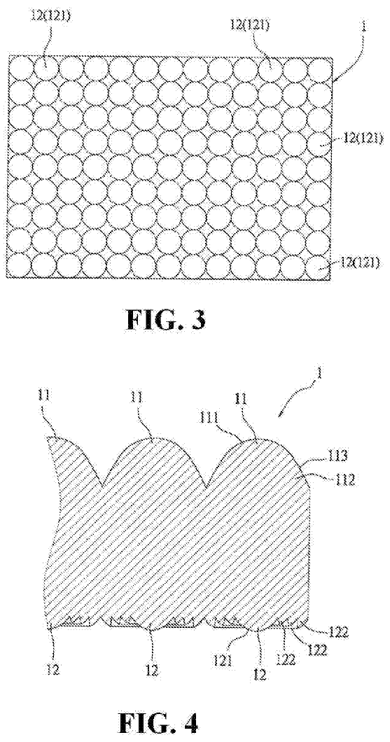

The present invention provides a light collector 1, wherein, the light collector 1 is a transparent board, the light collector 1 has an upper end provided with a plurality of light collecting projections 11 that are distributed densely, each of the light collecting projections 11 has an upper end provided with at least one light collecting curved surface 111 that increases an area and an angle for gathering light rays “A”; the light collector 1 has a lower end provided with a plurality of protruding Fresnel lenses 12 that are distributed densely, and each of the Fresnel lenses 12 has a lower end provided with at least one arcuate light output surface 121, as shown in FIGS. 2 and 3.

The light collecting projections 11 of the light collector 1 increase a multiple-angle gathering of the light rays “A”, the light collecting curved surface 111 of the light collecting projections 11 performs a polarizing treatment to the light rays “A” in the light collector 1, the polarized light rays “A” pass through the arcuate light output surface 121 of each of the Fresnel lenses 12 and are largely and straightly directed downward from the light collector 1, the light collector 1 is a very thin board to allow passage of the light, at the same time, the light rays “A” are collected by multiple angles, and the light rays “A” are largely directed downward and straightly irradiated. At the same time, the light collecting curved surface 111 has a proper refracting effect to the thermal energy “B” contained in the light rays “A”, as shown in FIGS. 2 and 3.

In order to increase the directly downward large irradiation quantity of the light rays “A” of the present invention, the arcuate light output surface 121 has a periphery provided with a plurality of (from one to five) arcuate light output rings 122. The light collecting projections 11 enhance the collecting area of the light rays “A”, thus, the upper part of the light collector 1 is provided with a light collecting cone rising column 112, the light collecting cone rising column 112 has a side provided with a light collecting cone curved surface 113 for increasing an upward collecting area of the light rays “A”, the top of the light collecting cone rising column 112 has the light collecting curved surface 111, and the light collecting cone curved surface 113 of the light collecting cone rising column 112 cooperates with the light collecting curved surface 111 to efficiently enlarge the collecting angle and the collecting area. Therefore, the light collector 1 made of a transparent board has a small volume and a very low cost, the light collector 1 is suitable for planting greenhouses, campuses, factories, offices, business stores, ordinary rooms, and the like. It can be seen that, the light collector 1 is the best choice for collecting the light rays “A” outdoors (for example: as shown in FIG. 4; in addition: the greenhouse, campus, factory, office, business store, and ordinary room, not drawn and labeled here).

The present invention is known from the above description that: the light collector 1 is a transparent board that has a small volume and a very low cost, the upper end of the light collector 1 is provided with the light collecting projections 11 for collecting the light rays “A”, the light collecting curved surface 111 of the light collecting projections 11 collect the light rays “A” by multiple angles, and the light rays “A” are polarized by the light collecting projections 11 simultaneously, and are gathered and irradiated straightly downward through the Fresnel lenses 12.

The technological content and technical features of the present invention have been disclosed as above, but those skilled in the art can still make various substitutions and modifications without departing from the spirit and scope of the invention. Therefore, the claims of the invention are not limited to the content disclosed by the embodiments of the invention, and the invention is intended to cover various alternatives and modifications.

1. A light collector, characterized in that, wherein, the light collector is a transparent board, the light collector has an upper end provided with a plurality of light collecting projections that are distributed densely, each of the light collecting projections has an upper end provided with at least one light collecting curved surface that increases an area and an angle for gathering light rays; the light collector has a lower end provided with a plurality of protruding Fresnel lenses that are distributed densely, and each of the Fresnel lenses has a lower end provided with at least one arcuate light output surface.

2. The light collector of claim 1, wherein the arcuate light output surface has a periphery provided with one to five arcuate light output rings.

3. The light collector of claim 1, wherein the light collecting projections are provided with a light collecting cone rising column, the light collecting cone rising column has a side provided with a light collecting cone curved surface for increasing an upward collecting area of the light rays, and the top of the light collecting cone rising column has the light collecting curved surface.
